(19) United States
(12) Patent Application Publication
(10) Pub. No.: US 2022/0053963 A1
(43) Pub. Date: Feb. 24, 2022

(54) FOLDABLE HOLDER

(71) Applicant: Yung Sen Cheng, Taichung City (TW)

(72) Inventor: Yung Sen Cheng, Taichung City (TW)

(21) Appl. No.: 17/405,470

(22) Filed: Aug. 18, 2021

(30) Foreign Application Priority Data
Aug. 20, 2020 (TW) 109128403

(51) Int. Cl. A47J 31/00; A47J 31/06

(52) U.S. Cl. CPC A47J 31/005; A47J 31/0689; A47J 31/0626

(57) ABSTRACT

A foldable holder includes a main body and a support base. The main body has a conical inner space. The support base in the form of a cone has an upper portion and a lower portion wider than the upper portion. A conical surface is formed between the upper portion and the lower portion. The upper portion is configured to support the main body. The main body and the support base are foldable.

### FIELD OF THE INVENTION

The present invention relates to a foldable holder that can be folded with ease for storage.

### BACKGROUND OF THE INVENTION

In recent years, making coffee has become more and more popular. There are various ways to make coffee. Compared with an electric coffee maker, most people prefer a mocha pot, siphon coffee maker, filter cup or drip coffee filter bag in terms of convenience. The filter cup is a favorite way to make coffee for most people. The filter cup is classified into two types, one needs a coffee paper filter, and the other is a metal filter mesh. Both structures have a conical inner space with the wide portion on the top. A flat disc-shaped support base is connected under the main body of the filter cup. The support base is placed on top of a container, and ground coffee is placed into the main body, and then hot water is poured into the main body, so that coffee flows out from the bottom of the filter cup into the container.

For most of filter cups, the main body is integrally formed with the support base to be one piece, as disclosed in US Patent Early Publication No. 2009/0178572. Some conical filter cups are provided with a bracket. No matter what kind of filter cup, it is inconvenient to carry because it takes up space.

There are a variety of solutions for carrying the filter cup more conveniently. For example, Taiwan Utility Model Publication No. M568102 discloses a coffee filter cup, which is a separable design for the main body and the support base. However, in this design, the main body is still a cone that occupies a space. Japanese Patent No. JPA2017-51477 discloses a combined filter cup. The combined filter cup is composed of three triangular plates to form a conical inner space, which is slightly troublesome for assembly. It is not beneficial to control the outflow of coffee, thus affecting the flavor of coffee. Besides, there is not enough width and a stable support portion to be placed on top of a wider container. Japanese Patent No. JPA2013-85639 discloses a filter cup that can be unfolded into a flat plate. In addition to the extremely difficult folding steps, the base is flat and cannot have enough strength to support the weight of the upper main body. Taiwan Utility Model Publication No. M353710 discloses a foldable filter cup. The main body is composed of several foldable rings, which is not conducive to the flow of coffee along the inner wall of the main body. In order to obtain sufficient support force, the base needs to be thicker. As a result, the weight is too heavy and the cost is relatively increased.

### SUMMARY OF THE INVENTION

The primary object of the present invention is to provide a foldable holder, which can be folded into a flat shape or unfolded into a flat plate shape. The structure is light and thin and provides sufficient support strength and stability.

Another object of the present invention is to provide a foldable holder, which is light in weight and low in cost.

A further object of the present invention is to provide a foldable holder, which provides a support base that can be directly placed with a paper filter.

In order to achieve the foregoing objects, the present invention provides a foldable holder, comprising a main body and a support base. The main body has an upper edge and a bottom. The upper edge has a diameter greater than that of the bottom to form a conical inner space. The support base, in the form of a cone, has an upper portion and a lower portion wider than the upper portion. A conical surface is formed between the upper portion and the lower portion. The upper portion is configured to support the main body.

### BRIEF DESCRIPTION OF THE DRAWINGS

FIG. 1 illustrates a first fan-shaped plate and a second fan-shaped plate according to a first embodiment of the present invention;

FIG. 2 is a schematic view, illustrating that the first fan-shaped plate and the second fan-shaped plate of FIG. 1 are combined with each other;

FIG. 3 illustrates that the first fan-shaped plate and the second fan-shaped plate of FIG. 2 are folded into a three-dimensional main body and a support base;

FIG. 4 is a schematic view, illustrating that the main body and the support base are placed above a cup according to the first embodiment of the present invention;

FIG. 5 is a schematic view according to a second embodiment of the present invention, illustrating that the main body is in the form of a cone and its two sides in the radial direction approach each other to form a cone, and the support base is unfolded into the first fan-shaped plate and partially connected to the main body;

FIG. 6 is a schematic view according to a third embodiment of the present invention, illustrating that the main body is integrally formed with the support base;

FIG. 7 is a schematic view of FIG. 6, illustrating that the support base is reversed toward the main body and the two are folded into a cone shape;

FIG. 8 is a schematic view, illustrating that the support base of FIG. 7 is turned outwardly;

FIG. 9 is a schematic view according to a fourth embodiment of the present invention;

FIG. 10 is a schematic view according to a fifth embodiment of the present invention;

FIG. 11 is a schematic view according to a sixth embodiment of the present invention;

FIG. 12 is a planar view, illustrating that the fan-shaped plate of FIG. 11 is folded into the main body and the support base;

FIG. 13 is a schematic view, illustrating that the main body of FIG. 12 is placed with a paper filter;

FIG. 14 is a schematic view, illustrating that the support base is placed on top of a cup;

FIG. 15 is a schematic view according to a seventh embodiment of the present invention; and

FIG. 16 is a schematic view according to an eighth embodiment of the present invention.

### DETAILED DESCRIPTION OF THE PREFERRED EMBODIMENTS

Embodiments of the present invention will now be described, by way of example only, with reference to the accompanying drawings.

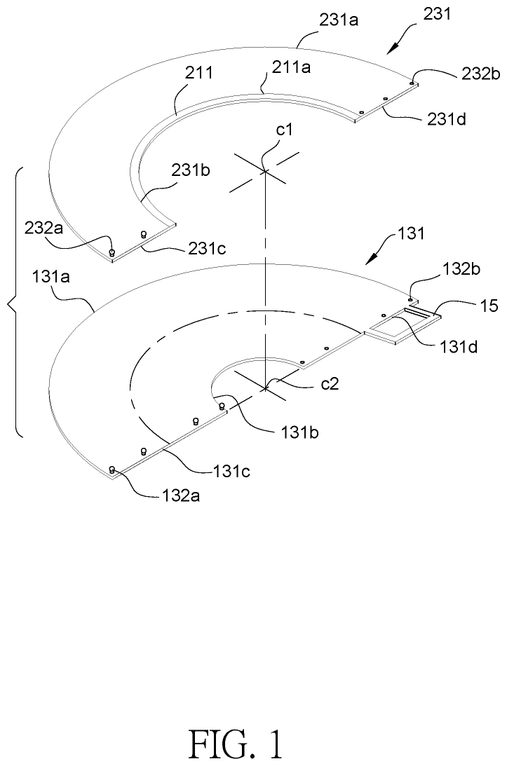

Referring to FIG. 1 through FIG. 4, a foldable holder applied to a filter cup for making coffee according to a first embodiment of the present invention comprises a first fan-shaped plate 231 and a second fan-shaped plate 131.

The first fan-shaped plate 231 has an upper arc area 231a and a lower arc area 231b according to the principle of unfolding a cone. Two arcs have the same central angle, and the center of the central angle is at the same point. This point is defined as a first center c1. The side areas 231c, 231d of the first fan-shaped plate, located on both sides of the central angle, are connected to form a cone-shaped support base 2 having an upper portion 21 and a lower portion 22 wider than the upper portion. A conical surface 23 is formed between the upper portion and the lower portion.

The second fan-shaped plate 131 has an upper arc area 131a and a lower arc area 131b according to the principle of unfolding a cone. The centers of the two arcs are at the same point. This point is defined as a second center c2. The side areas 131c, 131d of the second fan-shaped plate, located on both sides of the central angle, have fastening structures that can be fastened together, for example, a protrusion 132a having a spherical end and a fastening hole 132b, as shown in FIG. 1. When in use, the protrusion 132a and the fastening hole 132b are fastened and connected to form a conical main body 1 having an upper edge 11 and a bottom 12. The diameter of the upper edge is greater than that of the bottom to form a conical inner space 13.

In this embodiment, both the first fan-shaped plate 231 and the second fan-shaped plate 131 may be made by cutting a platy material. The platy material is selected from one of a plastic plate, silicone plate, rubber plate, cardboard, metal plate, and metal mesh.

The first fan-shaped plate has a coupling portion 211 extending from the lower arc area 231b. The coupling portion is on an arc with the first center c1 as its center, for example, an arc surface in this embodiment. In production, the first fan-shaped plate 231 and the second fan-shaped plate 131 are combined as shown in FIG. 2. The second center c2 is aligned with the first center c1, and then the first fan-shaped plate 231 and the second fan-shaped plate 231 are connected by one of hot melting, high-frequency, bonding, spot welding, and riveting through the coupling portion 211 according to the material characteristics of the two.

The side areas 131c, 131d of the second fan-shaped plate, located on both sides of the central angle, have fastening structures that can be fastened together, for example, a protrusion 132a having a spherical end and a fastening hole 132b, as shown in FIG. 1. When in use, the protrusion 132a and the fastening hole 132b are fastened and connected for the second fan-shaped plate to form the conical main body 1 having the conical inner space 13. On the other hand, the first fan-shaped plate 231 is folded into a downwardly sloping cone. Two ends of the first fan-shaped plate have fastening structures that can be fastened together, for example, a protrusion 232a having a spherical end and a fastening hole 232b, as shown in the figures. When in use, the protrusion 232a and the fastening hole 232b are fastened and connected for the first fan-shaped plate to become the cone-shaped support base 2. The upper portion 21 is circumferentially connected to the middle section of the main body.

In this embodiment, in order to make the first fan-shaped plate 231 easily be folded into a downwardly expanding cone, the coupling portion 211 and the lower arc area 23 lb are separated by a fold line 211a. The first fan-shaped plate is folded from the fold line into a cone opposite to the second fan-shaped plate. It can be restored to its original shape when stored.

The connection of the two side areas of the first fan-shaped plate and the second fan-shaped plate may be achieved by one of a fastening structure, hot melting, high frequency, bonding, spot welding, and riveting.

The second fan-shaped plate 131 and the first fan-shaped plate 231 have the same inclination. The first fan-shaped plate 231 has a relatively short radial width. When the first fan-shaped plate 231 becomes the support base 2, its upper portion 21 corresponds to the middle section of the main body, so that the overall weight of the main body can be supported close to the center of gravity when making coffee. This is more stable. When in use, the bottom 12 of the main body won't extend too much into the lower container, and the bottom 12 of the main body is located below the upper portion 21 of the support base to form an inner wall protruding from the conical surface 23, such that coffee flows out more centrally.

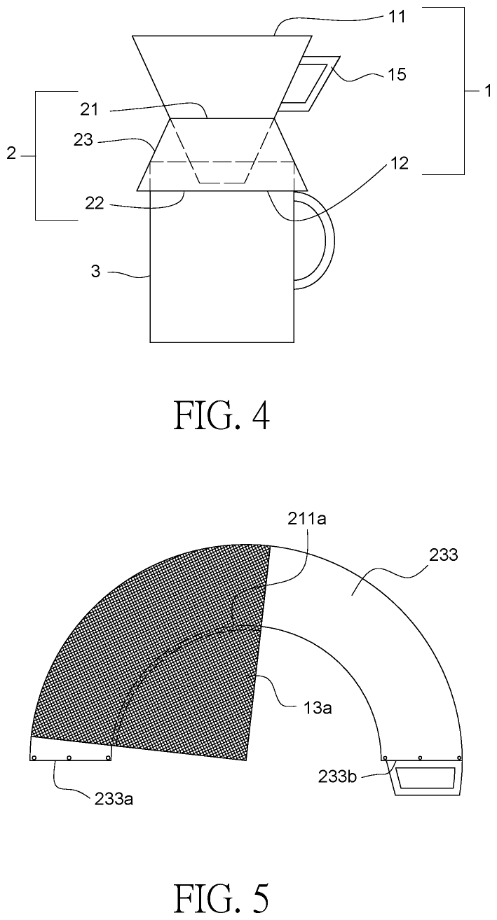

As shown in FIG. 4, the inner wall of the conical surface of the support base is placed above the container 3 such as a cup when in use. A paper filter (not shown in the figure) is placed in the main body, such as a common conical paper filter, and then ground coffee is placed into the paper filter. Water is poured in the ground coffee for making coffee. For a 4-cup filter cup, the capacity of water to be poured is about 300 ml, so the weight is completely borne by the support base. Because the support base is in a conical shape, it has better longitudinal flexural strength than a flat structure. The larger the angle of the conical surface of the support base, the better the strength. For example, for the main body of a general-purpose V60 paper filter, the inclination of the main body is about 60 degrees. The conical surface of the support base has the same inclination, which has sufficient support strength. In addition, the conical support base is beneficial to be placed on containers of different calibers.

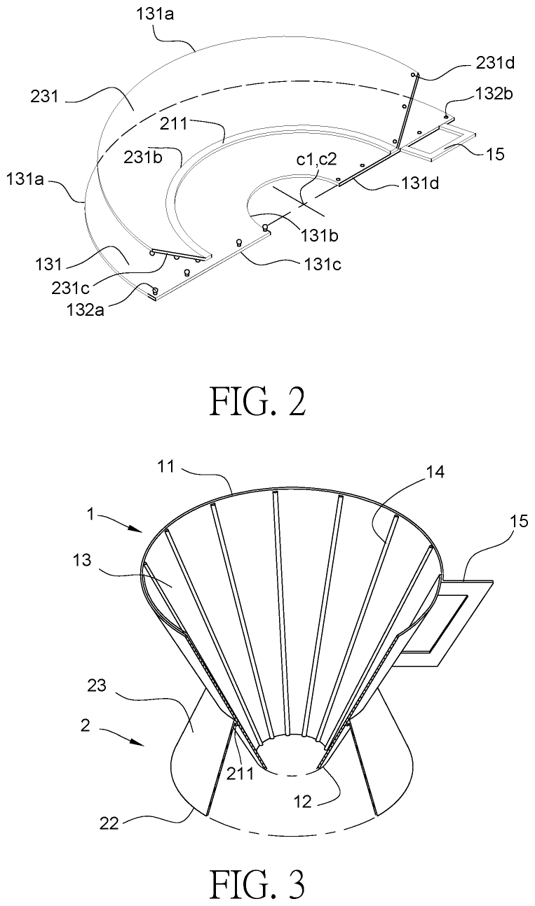

For the use of a flat conical paper filter, in order to facilitate the guide of coffee, the inner surface of the main body 13 has a plurality of ribs 14 extending longitudinally, as shown in FIG. 3.

In order to facilitate movement, a handle 15 extends from one side area of the second fan-shaped plate with a fold line. When the second fan-shaped plate becomes the main body, the handle is folded outwardly along the fold line. Alternatively, a handle extends from one side area of the first fan-shaped plate with a fold line. When the first fan-shaped plate becomes the support base, the handle is folded outwardly along the fold line.

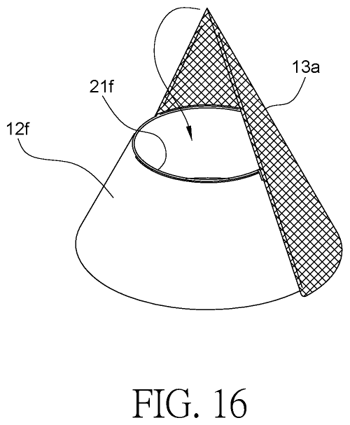

FIG. 5 shows a second embodiment of the present invention. The main body la is made of one of a metal filter mesh, filter paper, and non-woven fabric. The lower end of the main body is formed with a pointed cone, so there is no need to place a paper filter. The two opposite sides in the radial direction of the main body la may be folded into a flat shape. The two ends 233a, 233b of the first fan-shaped plate 233 are in an unfolded state, and part of the lower arc area has a coupling portion 211a coupled to the main body. The principle of this embodiment can be further applied to the embodiment as shown in FIG. 16. The support base 12f is made in a cone shape, and the two opposite sides in the radial direction are folded into a flat shape. After the support base 12f is unfolded, the pointed end of the main body 13a is flexibly inserted into the opening formed by the upper portion 21f, and then the main body is unfolded into a cone.

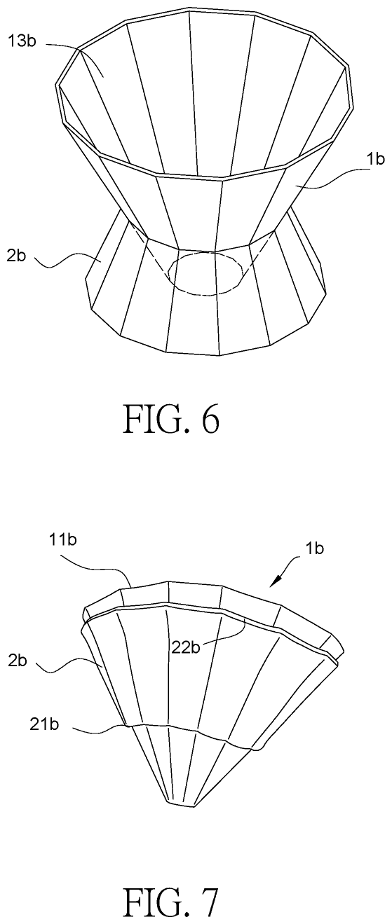

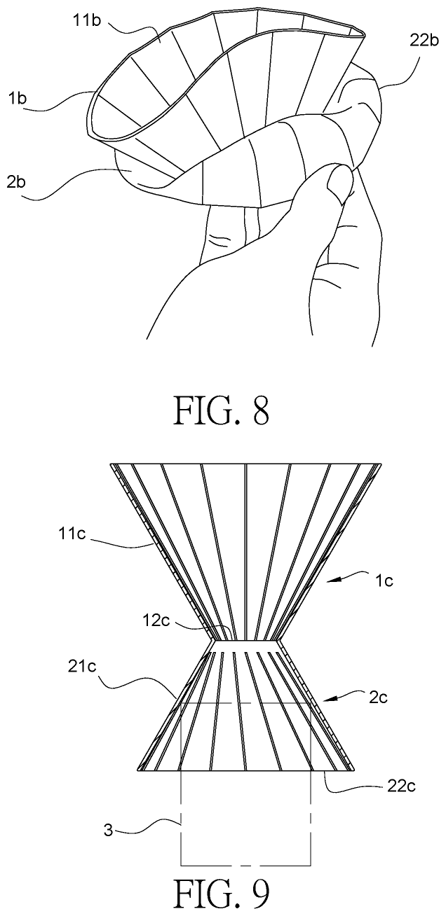

FIGS. 6-8 show a third embodiment of the present invention. The main body lb and the support base 2b are integrally formed with a flexible material, such as plastic, rubber and silicon, by using a mold, so that the upper portion of the support base 21b is integrated with the main body 13b. Because the three-dimensional support base and main body cannot be directly pressed into a flat shape due to the different directions of inclination, the support base made of a flexible material is folded from the lower portion 22b toward the upper edge 11b of the main body. The inclination of the two is the same, so that the two opposite sides in the radial direction of the main body and the support base can be folded into a flat shape or curled to facilitate storage. This principle is also applicable to other embodiments of the present invention. As shown in FIG. 8, when it is to be used again, the support base is turned downwardly to be in the state shown in FIG. 6.

FIG. 9 shows a fourth embodiment of the present invention. The main body and the support base are integrally formed with a flexible material, such as plastic, rubber and silicon rubber, by using a mold. Especially, the bottom 12c of the main body and the upper portion 21c of the support base are joined at the same position. In use, the main body 1c may be reversed to face down, and the support base 2c faces up. The support base is used for making coffee, and the main body is used for supporting. With this structure, the main body and the support base are designed to have different axial heights, which can be used for making coffee with different capacities. The inner walls of the main body and the support base may be designed with different guide effects. Similarly, the support base is folded from the lower portion 22c toward the upper edge of the main body, the two opposite sides in the radial direction of the main body and the support base can be folded into a flat shape for storage.

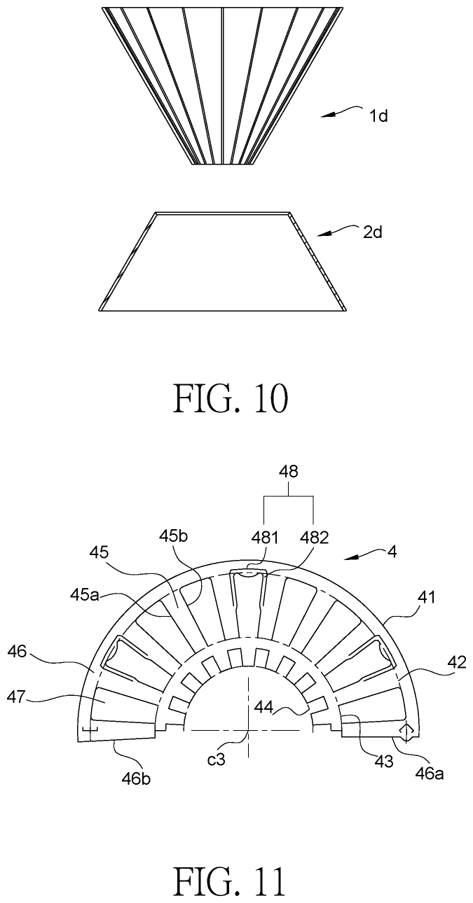

FIG. 10 shows a fifth embodiment of the present invention. The main body 1d and the support base 2d are independent components and are in the form of a cone, respectively. The two may be sleeved with each other when storing. In addition, the main body and the support base may be flexible. The two opposite sides in the radial direction of the main body and the support base can be folded into a flat shape. In this embodiment, the main body and the support base may be designed with the same or different inclinations.

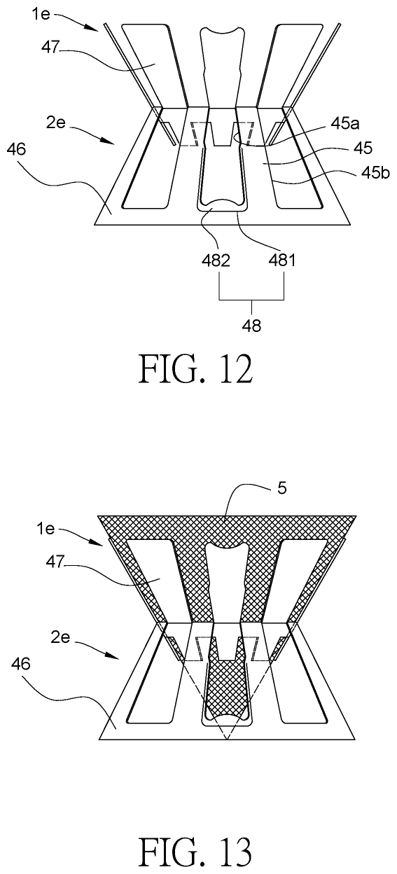

FIGS. 11-14 show a sixth embodiment of the present invention. The main body and the support base consist of a fan-shaped plate. The fan-shaped plate 4 is selected from one of a plastic plate, silicone plate, rubber plate, cardboard, mesh and metal plate. The fan-shaped plate defines a center point c3 and an outer arc edge 41, a first arc line 42, a second arc line 43 and an inner arc edge 44 with the center point as the central angle. The first arc line 42 is between the outer arc edge 41 and the second arc line 43. The inner arc edge 44 is between the center point c3 and the second arc line 43. The fan-shaped plate has side areas 46a, 46b located on both sides of the central angle. The two side areas are connected to form a cone. The connection of the two side areas is achieved by one of a fastening structure, hot melting, high frequency, bonding, spot welding, and riveting.

A plurality of connecting ribs 45 are provided between the first arc line and the second arc line. Each connecting rib consists of two side lines 45a, 45b that are spaced apart with a considerable width. A plurality of cutting lines are formed along the first arc line between the side lines of every adjacent two of the connecting ribs and the side lines 45a, 45b of the connecting ribs. Therefore, between the outer arc edge and the first arc line, the connecting ribs and the side areas constitute a support base forming area 46, and the rest of the fan-shaped plate constitutes a main body forming area 47. When in use, the support base forming area is folded toward the center point c3 with the second arc line 43 as the boundary, and the side areas 46a, 46b on both sides are fastened together, so that the support base 2e and the main body 1e are formed simultaneously.

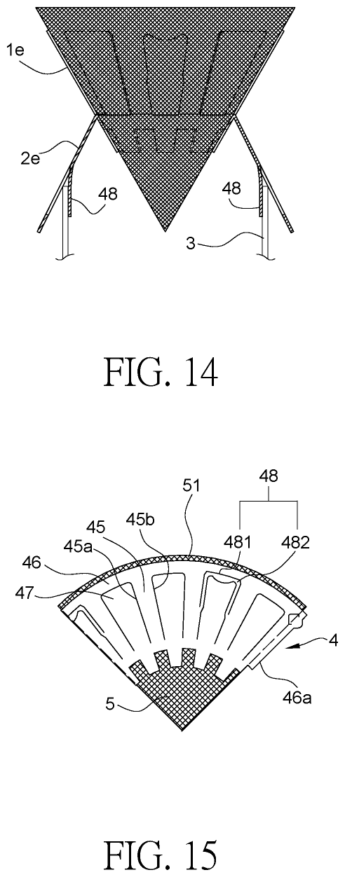

The support base forming area is provided with a plurality of blocking pieces 48. The blocking piece consists of a U-shaped cutting line 481 along every adjacent two of the connecting ribs and the area between the outer arc edge and the first arc line, so that it has a lower end portion 482 to be bent inwardly toward the support base. Thus, when the support base is placed on top of a cup, the blocking pieces 48 can be folded toward the rim of the cup, so that the support base is more stable on the cup, as shown in FIG. 14.

FIG. 15 shows a seventh embodiment of the present invention. The side areas 46a, 46b on both sides of the fan-shaped plate shown in FIG. 11 are relatively folded in half to form a conical unit 5 clamped between two folded portions side by side. The conical unit is made of a flexible material selected from one of plastic, rubber, silicon rubber, filter mesh, filter paper and non-woven fabric, but not limited thereto. The conical unit 5 is a three-dimensional cone to be folded into a fan-shaped plane, and has a large arc 51 in a direction corresponding to the outer arc edge 41 of the fan-shaped plate. At least part of the main body forming area 47 of the fan-shaped plate is attached or fixed to the conical unit. Taking the conical unit made of filter paper as an example, the user can unfold the filter paper while folding the fan-shaped plate into a three-dimensional shape, which can be directly used as a filter cup. If the conical unit is made of a plastic material, it can be made into a truncated cone to have an opening at the lower end (not shown). A paper filter is placed into the unfolded conical unit. In use, the water permeating the paper filter flows out from the opening.

Based on the above examples, in addition to achieving a very small storage volume, the present invention is designed to be a thinner structure, so it is light in weight and easy to carry. The use of a platy metal has the characteristics of low cost.

What is claimed is:

1. A foldable holder, comprising:
a main body, having an upper edge and a bottom, the upper edge having a width greater than that of the bottom to form a conical inner space;
a support base in the form of a cone, having an upper portion and a lower portion wider than the upper portion, a conical surface being formed between the upper portion and the lower portion, the upper portion surrounding and being connected to the main body;
the lower portion of the support base being foldable toward the upper edge of the main body.

2. The foldable holder as claimed in claim 1, wherein the support base consists of a first fan-shaped plate, according to the principle of unfolding a cone, the first fan-shaped plate has a first center, an upper arc area corresponding to the upper portion with the first center as a central angle, and a lower arc area corresponding to the lower portion with the first center as the central angle; the first fan-shaped plate has side areas located on both sides of the central angle, and the two side areas are connected to form the cone.

3. The foldable holder as claimed in claim 2, wherein the first fan-shaped plate is made by cutting a platy material, the platy material is selected from one of a plastic plate, silicone plate, rubber plate, cardboard, mesh and metal plate, and the two side areas of the first fan-shaped plate are connected by one of a fastening structure, hot melting, high frequency, bonding, spot welding, and riveting.

4. The foldable holder as claimed in claim 3, wherein the main body is formed with a flexible material selected from one of plastic, rubber, silicon rubber, mesh, filter mesh and filter paper.

5. The foldable holder as claimed in claim 2, wherein the main body consists of a second fan-shaped plate, according to the principle of unfolding a cone, the second fan-shaped plate has a second center, an upper arc area corresponding to the upper edge with the second center as the central angle, and a lower arc area corresponding to the bottom with the second center as the central angle; the second fan-shaped plate has side areas located on both sides of the central angle, and the two side areas are connected to form the cone.

6. The foldable holder as claimed in claim 5, wherein the second fan-shaped plate is made by cutting a platy material, the platy material is selected from one of a plastic plate, silicone plate, rubber plate, cardboard, mesh and metal plate, and the two side areas of the second fan-shaped plate are connected by one of a fastening structure, hot melting, high frequency, bonding, spot welding, and riveting.

7. The foldable holder as claimed in claim 1, wherein the main body and the support base is formed with a flexible material selected from one of plastic, rubber, silicon rubber, mesh, filter mesh and filter paper.

8. The foldable holder as claimed in claim 7, wherein the upper portion of the support base is joined between the bottom and the upper edge of the main body.

9. The foldable holder as claimed in claim 7, wherein the bottom of the main body and the upper portion of the support base are joined at a same position.

10. The foldable holder as claimed in claim 1, wherein the main body and the support base consist of a fan-shaped plate, the fan-shaped plate defines a center point and an outer arc edge, a first arc line and a second arc line with the center point as a central angle, the first arc line is between the outer arc edge and the second arc line; the fan-shaped plate has side areas located on both sides of the central angle, the two side areas are connected to form a cone;
a plurality of connecting ribs are provided between the first arc line and the second arc line, each connecting rib consists of two side lines that are spaced apart with a considerable width; a plurality of cutting lines are formed along the first arc line between the side lines of every adjacent two of the connecting ribs and the side lines of the connecting ribs, between the outer arc edge and the first arc line, the connecting ribs and the side areas constitute a support base forming area, the rest of the fan-shaped plate constitutes a main body forming area; the support base forming area is folded toward the center point with the second arc line as a boundary, and the side areas on both sides are connected, thereby forming the support base and the main body simultaneously.

11. The foldable holder as claimed in claim 10, wherein the fan-shaped plate has an inner arc edge between the center point and the second arc line with the center point as the central angle.

12. The foldable holder as claimed in claim 10, wherein the fan-shaped plate is one of a plastic plate, silicone plate, rubber plate, cardboard, mesh and metal plate.

13. The foldable holder as claimed in claim 11, wherein the fan-shaped plate is one of a plastic plate, silicone plate, rubber plate, cardboard, mesh and metal plate.

14. The foldable holder as claimed in claim 11, wherein the support base forming area is provided with at least one blocking piece consisting of a U-shaped cutting line, and the blocking piece has a lower end portion to be bent inwardly toward the support base.

15. The foldable holder as claimed in claim 10, wherein the side areas on both sides of the fan-shaped plate are folded in half to form two folded portions side by side, a conical unit is clamped between the two folded portions, the conical unit is a three-dimensional cone to be folded into a fan-shaped plane, and the conical unit has a large arc in a direction corresponding to the outer arc edge of the fan-shaped plate; and at least part of the main body forming area of the fan-shaped plate is coupled to the conical unit.

16. The foldable holder as claimed in claim 11, wherein the side areas on both sides of the fan-shaped plate are folded in half to form two folded portions side by side, a conical unit is clamped between the two folded portions, the conical unit is a three-dimensional cone to be folded into a fan-shaped plane, and the conical unit has a large arc in a direction corresponding to the outer arc edge of the fan-shaped plate; and at least part of the main body forming area of the fan-shaped plate is coupled to the conical unit.

17. The foldable holder as claimed in claim 15, wherein the conical unit is formed with a flexible material selected from one of plastic, rubber, silicon rubber, mesh, filter mesh, filter paper and non-woven fabric.

18. The foldable holder as claimed in claim 16, wherein the conical unit is formed with a flexible material selected from one of plastic, rubber, silicon rubber, mesh, filter mesh, filter paper and non-woven fabric.

19. The foldable holder as claimed in claim 15, wherein the conical unit is a truncated cone having an opening at its lower end.

20. The foldable holder as claimed in claim 16, wherein the conical unit is a truncated cone having an opening at its lower end.
